(19) United States
(12) Patent Application Publication
(10) Pub. No.: US 2012/0243509 A1
(43) Pub. Date: Sep. 27, 2012

(54) METHOD FOR COMMUNICATING INFORMATION

(75) Inventors: Petar Popovski, Aalborg SV (DK); Zoran Utkovski, Ulm (DE)

(73) Assignees: UNIVERSITÄT ULM, Ulm (DE); AALBORG UNIVERSITET, Aalborg Ø (DK)

(21) Appl. No.: 13/511,590

(22) PCT Filed: Nov. 15, 2010
(86) PCT No.: PCT/DK2010/050307

§ 371 Date: May 23, 2012

(30) Foreign Application Priority Data
Nov. 29, 2009 (DK) PA 2009 01258

(51) Int. Cl. H04W 8/22; H04W 36/00; H04W 16/02; H04W 72/04

(52) U.S. Cl. 370/331; 370/328; 370/329; 370/335

(57) ABSTRACT

The invention relates to a method for communicating intended information between a sender and at least one receiver in a communication system. The method comprises providing a plurality of elements to be sent from the sender to the receiver, the plurality of elements being in a first order; sending to the receiver the elements in a second order, the second order representing the intended information; receiving the plurality of elements; determining whether an order in which the elements have been received is different from the first order; if the order in which the elements have been received is different from the first order, determining an information based on the order in which the elements have been received; and if the order in which the elements have been received is the second order, the information determined is the intended information.

### FIELD OF THE INVENTION

The present invention relates to a method and system for communicating information in a communication system, especially in a wireless system.

### BACKGROUND OF THE INVENTION

One of the fundamentals of all packet-based communications is that the packet carries overhead information which tells how the packet should be delivered: to which destination, in which order, etc. For example, the Internet Protocol (IP) packets have a substantial header which carries information that is related to the protocol, but the substantial header does not carry any useful data for the end user. Hence, an improved technique to carry useful information for the end user would be advantageous.

### OBJECT OF THE INVENTION

It may be seen as an object of the present invention to provide a method and a system that allows the transfer of additional and useful information to the end user and which solves the above mentioned problem.

### SUMMARY OF THE INVENTION

The above described object and several other objects is obtained in a first aspect of the invention by providing a method for communicating an intended information between a sender and a receiver in a communication system, the method comprising:
a) providing a plurality of elements to be sent from the sender to the receiver, the plurality of elements being in a first order;
b) sending to the receiver the elements in a second order, the second order representing the intended information;
c) receiving the plurality of elements;
d) determining whether an order in which the elements have been received is different from the first order;
e) if the order in which the elements have been received is different from the first order, determining an information based on the order in which the elements have been received;
f) if the order in which the elements have been received is the second order, the information determined is the intended information.

The receiver may be one of several receivers in the system, and the intended information may be sent to any number of the receivers.

The invention is particularly, but not exclusively, advantageous for obtaining additional in-band capacity, i.e. extra bits of information without having to send extra bits of data. The extra bits of information may be used for various purposes within the same system or across various systems. The invention leverage from the order existing or from the order given to a communication to create an order that carries additional and useful information for the receiver, e.g., the end user.

In a second aspect, the invention relates to a receiver apparatus comprising at least one of the following:
a) a means for receiving a plurality of elements from a sender;
b) a means for determining whether an order in which the elements have been received is different from the first order;
c) if the order in which the elements have been received is different from the first order, a means for determining an information based on an order in which the plurality of elements are received;
d) a means for determining an information based on a header of an element received on a channel in a communication system.

In a third aspect, the invention relates to a sender apparatus comprising:
a) a means for providing a plurality of elements to be sent to the at least one receiver, the plurality of elements being arranged in a first order;
b) a means for sending to the at least one receiver the plurality of elements in a second order, the second order representing an information to be communicated to the receiver.

In a fourth aspect, the invention relates to a system for communicating intended information from a sender to a receiver comprising:
a) a sender apparatus adapted to:
i. provide a plurality of elements to be sent from the sender to the at least one receiver, the plurality of elements being arranged in a first order;
ii. send to the at least one receiver the plurality of elements in a second order, the second order representing the intended information;
b) a receiver apparatus adapted to:
iii. receive a plurality of elements;
iv. determine whether an order in which the elements have been received is different from the first order;
v. If the order in which the elements have been received is different from the first order, determining an information based on the order in which the elements have been received;
vi. If the order in which the elements have been received is the second order, the information determined is the intended information.

In a fifth aspect, the invention relates to a computer program product being adapted to enable a computer system comprising at least one computer having data storage means in connection therewith to control a system or an apparatus according to the first aspect of the invention.

This aspect of the invention is particularly, but not exclusively, advantageous in that the present invention may be accomplished by a computer program product enabling a computer system to carry out the operations of the apparatus/ or system of the first aspect of the invention when down- or uploaded into the computer system. Such a computer program product may be provided on any kind of computer readable medium, or through a network.

In a sixth aspect the present invention relates to a method for transmitting a plurality of data from a first device to a second device via a data transmission network, communication via the data transmission network being defined by a first data protocol defining a first order in which data packages are to be transmitted, a second data protocol defining a set of information words based on order of data packages of the first protocol, the method comprising: the first device ordering the plurality of data in a first sequence of packages to transmit via the data transmission network, reordering the first sequence of data packages to a second sequence in accordance with the second data protocol to form second information, transmitting packages from the first device in the second sequence to the second device, decoding at the second device the second sequence to obtain the second information.

Advantageously the method may comprise reordering the plurality of data in the second sequence into the first sequence. This may be done to allow the first data protocol to correctly decode the transmitted data.

Any features of the individual aspects of the present invention may be combined with any of the other aspects. These and other aspects of the invention will be apparent from the following description with reference to the described embodiments.

### BRIEF DESCRIPTION OF THE FIGURES

The invention will now be described in more detail with regard to the accompanying figures. The figures show one way of implementing the present invention and is not to be construed as being limiting to other possible embodiments falling within the scope of the attached claim set.

FIG. 1 shows the architecture illustrating entities comprised in the systems for communicating information from a sender to a receiver,

FIG. 2 shows a flowchart illustrating an exemplary implementation of the method of the invention,

FIG. 3a shows a flowchart illustrating another exemplary implementation of the method of the invention with an additional step of arrangement,

FIG. 3b shows a flowchart illustrating another exemplary implementation of the method according to the invention with an additional step of header analysis,

FIG. 4 shows for example an arrangement of a plurality of terminals over a plurality of channels in a second order representing the information to be communicated to the at least one receiver,

FIG. 5 shows another example of an arrangement of a plurality of channel assigned to a plurality of terminals and packets and in a second order representing the information to be communicated to the at least one receiver,

FIG. 6 shows another example of an arrangement of a plurality of terminals over available downlink channels from a first order to a second order,

FIG. 7 shows another example of an arrangement of a plurality of terminals' data packets over a channel,

FIG. 8 shows a similar example as in FIG. 7, except that the arrangement of the plurality of data packets over a channel from first order to second order 802 is performed according to the Sequence Control field,

FIG. 9 shows an example an arrangement of a plurality of terminals over a channel, the arrangement in a sequence representing information, FIG. 10 shows an application of the present invention in a cognitive radio system,

FIG. 11 is a schematic illustration of packages in a frame which has 8 slots for sending packets, but only 5 packets that are sent and 3 slots are empty,

FIG. 12 is a schematic illustration of packages in a frame which has 8 slots for sending packets, but the receiving device can only differentiate between a packet (1) and no packet (0),

FIG. 13 is a schematic illustration of five transmitter units using short-range radio technology to exchange data,

FIG. 14 is a schematic illustration of format of a packet used in a short-range radio technology, and

FIG. 15 is a schematic illustration of communication possibilities between four communication units with increasing distance.

### DETAILED DESCRIPTION OF AN EMBODIMENT

In accordance with the invention there is provided a system, a method, a receiver apparatus, a sender apparatus, a computer program for communicating an intended information from a sender to at least one receiver using the ordered arrangement of a plurality of elements sent to the same or to other receivers. The receivers may have to be in the same communication range or the same radio range in order to overhear the order in which the plurality of elements are sent, and thus derive the intended information.

In the context of the present description, the term “sender” refers to a sender apparatus comprising at least one of the following:
c) a means for providing a plurality of elements to be sent from the sender to the receiver, the plurality of elements being arranged in a first order;
d) a means for sending to the at least one receiver the plurality of elements in a second order, the second order representing the information to be communicated to a receiver.

A sender may also be adapted to receive an element or a plurality of elements from another apparatus. A sender apparatus may comprise a transceiver allowing transmission and reception of an element. The transmission and reception may be performed via a radio channel, or a wireless link. The sender also has a computing capability allowing it to at least generate combinatorial sequences.

As used herein the term “receiver” refers to a receiver apparatus comprising at least one of the following:
a) a means for receiving a plurality of elements;
b) a means for determining whether an order in which the elements have been received is different from the first order;
c) a means for determining an information based on an order in which the plurality of elements are received;
d) a means for determining an information based on a header of an element received on a control channel in a communication system.

A receiver may also be adapted to send an element or a plurality of elements from another apparatus. A receiver apparatus may comprise a transceiver allowing transmissions and receptions of elements. The transmission and reception may be performed via a radio channel, or a wireless link. In a useful embodiment, the receiver is also adapted to receiving from a sender a plurality of elements not destined to the receiver. A receiver apparatus also has a computing capability allowing it to at least deriving the information intended from the received order.

As used herein the term “element” refers to a block of arbitrary information, or a resource for storing information, which is available to a computer program. An element when related to data may take the form of a sequence of bits or bytes. An element is a data block, a data packet, a code, a channelization code, a resource, a frequency, a time interval, an address, a terminal or a combination thereof. In the context of the invention, the term “terminal” is selected a device selected from a group consisting of a receiver, a sender, a transceiver, or a combination thereof.

According to the invention, the plurality of elements is encapsulated in a frame over which the invention is performed.

In one aspect of the invention, the invention provides a system for communicating an intended information from a sender to a receiver comprising:
a) A sender apparatus adapted to:
   i. Be provided with a plurality of elements to be sent from the sender to the at least one receiver, the plurality of elements being arranged in a first order;
   ii. to send to the at least one receiver the plurality of elements in a second order representing the information;
b) A receiver apparatus adapted to:
   i. receive a plurality of elements;
   vii. determine whether an order in which the elements have been received is different from the first order;
   ii. If the order in which the elements have been received is different from the first order, determining an information based on the order in which the elements have been received;
   iii. If the order in which the elements have been received is the second order, the information determined is the intended information.

The system may also comprise a receiver apparatus adapted to at least one of the following:
iv. determine whether an order in which the elements have been received is different from the first order;
v. If the order in which the elements have been received is different from the first order, determining the information based on the order in which the elements have been received;
vi. determine an information based on a header of an element received.

In a useful embodiment, the header of the element is received on a control channel in a communication system.

A method could include ordering data or elements at a first sender unit and forwarding the data in that order to a second sender unit. The second sender unit could then act as a relay forwarding the data to a third sender unit or a receiver or destination unit, where the data could be interpreted and re-ordered.

The proposed methods of communication may be seen as a class of techniques for doing protocol coding, referring to the transmission strategies that convey additional information by utilizing the degrees of freedom available when deciding the set of actions to be followed by a communication protocol. In this particular description, such communication may be carried out by reordering of resources that are assigned to the users, where a resource may be a channel, a packet, a transmission time, or the like.

Consider a primary or first communication protocol, which is used by a Base Station (BS) to communicate with multiple primary users or terminals that are in the coverage area of the BS. Each primary user or terminal of the first system has a unique identity ui, which is an integer and the identities can be ordered in ascending order as u1, u2, u3, . . . . For simplicity, TDMA systems are assumed, with a single channel that is utilized to send data to all the users or terminals. The BS serves the users in scheduling frames. Each frame consists of F packet transmissions, where F is a predefined number. During this epoch the BS sends F packets, addressed to m≦F primary users, such that it can happen that one user receives more packets during an epoch. Each frame consists of frame header, which states to which user is each of the packets in the frame intended. The set of scheduled users is U={ui1, ui2, . . . uim}, where i1<i2< . . . <im. Thus, the frame header defines a permutation (possibly with repetitions) of length F. Based on the unique ordering of the users in U, each permutation can uniquely be written by a permutation of length F defined on the set {1, 2, . . . m}.

In the coverage area of the BS there are also secondary receivers. These receivers are not required to decode completely all the F packets, but rather only the frame header and, perhaps, the headers of some of the packets in the frame. The BS sends information to the secondary users by reordering the packets in a frame. Each frame is one symbol for secondary or second communication and coding is done over multiple frames.

In one model, the frame size is fixed to F and the number of scheduled users is always m=F. This model is used, for example, when each packet is addressed to a different user. Alternatively, if the secondary receivers can read the inner headers of the packets, then if there are more than one packet intended to the user ui, each packet has a distinct number, written in its header. For example, let F=6 and let only 3 users be served with U={4, 7, 12}, such that there are 2 packets for user 4, 1 packet for user 7 and 3 packet for user 12. Let the ordered pair (ui, j) denote the j-th packet of the ui-th user in the frame. Then, the packets can be ordered by first ordering the users and then the packets for each user. In this example, the ascending order would be (4, 1), (4, 2), (7, 1), (12, 1), (12, 2), (12, 3), which uniquely corresponds to 1, 2 . . . 6 and any scheduling of the packets defines a permutation of length 6.

In order to illustrate the concepts in this invention with some real-life examples, the IEEE 802.16 (WiMAX) system is considered. In WiMAX, a base station (BS) schedules downlink traffic for the subscribe stations (SS). The traffic is categorized in five service classes according to priority. Each SS must register at the BS before and negotiate the initial QoS requirements with the BS. These requirements can be changed later, and a new connection may also be established on demand.

The basic approach for providing the QoS guarantees in the WiMAX network is that the BS does the scheduling for both the uplink and downlink directions. In other words, an algorithm at the BS has to translate the QoS requirements of SSs into the appropriate number of slots in the frame. When the BS makes a scheduling decision, it informs all SSs about it by using the UL-MAP and DL-MAP broadcasts messages in the beginning of each frame. These special messages define explicitly slots that are allocated to each SS in both the uplink and downlink directions. The scheduling policy, i.e. an algorithm to allocate slots, is not defined in the WiMAX specification, but is rather left open for customary implementations.

Independent of the scheduling policy, there is a possibility to assign explicitly each slot to some connection. The BS can freely choose the order of the slots which are assigned to the SSs within the frame. Clearly, by reordering the slots in the frame additional information can be sent. The secondary users for which this information is intended have only to read the broadcast DL-MAP or UL-MAP messages. The amount of additional information that can be transmitted within one frame (typically duration of 5 ms) is not negligible, since usually more than hundred time slots and more than ten SSs are available, leaving place for substantial combinatorial reordering.

Taking an example where the number of physical slots is F=100 and the number of active SSs (users) is K=10. Furthermore, let the QoS requirements of the users be such that the number of slots assigned to the SSs be respectively 6,2,6,9,7,10,10,20,15,15. The number of bits obtained by the different ordering of the subchannels is thus Nb=log 2[100!/(2!6!6! . . . 20!)]≈288.85 bits which for a frame of duration of 5 ms gives Nb≈57.7 [kbps].

The protocol overhead that is always present in communication systems, under certain conditions, can be utilized to send additional information. The original communication system, the overhead of which is utilized to send the additional information, is referred to as a primary system. On the other hand, the communication system that utilizes the additional information is called secondary or second communication system. However the secondary system can be the primary system in the sense that it may also use the additional information provided by the current invention.

According to the invention, methods for secondary communication that are based on rearranging the transmission order of the packets from the primary communication system have been considered. The primary communication system is frame-based and it determines a set of packets that need to be delivered within a frame, but the arrangement of the packets within a frame is irrelevant for the primary system. Using parameters for a WiMAX system, the practical data rates that can be obtained by this communication method have been illustrated.

Firstly, stochastic arrivals of packets in the primary system can be considered and a buffering margin for the secondary communication is allowed—that is, the secondary system may buffer the packets for a limited time, thus obtaining a larger diversity of packets and sending at higher rate (e.g. it waits until it can create a permutation, instead of sending two or more packets with the same ID within the same frame).

Next, it is interesting to explore what are the practical coding schemes that can be applied for the combinatorial model. Another interesting direction is to consider models in which the primary puts additional constraints on packet rearrangement. For example, in systems with adaptive modulation, the primary system does not want to put a primary user over a channel that is bad for that user—hence, the rearranging of the users/channels is constrained.

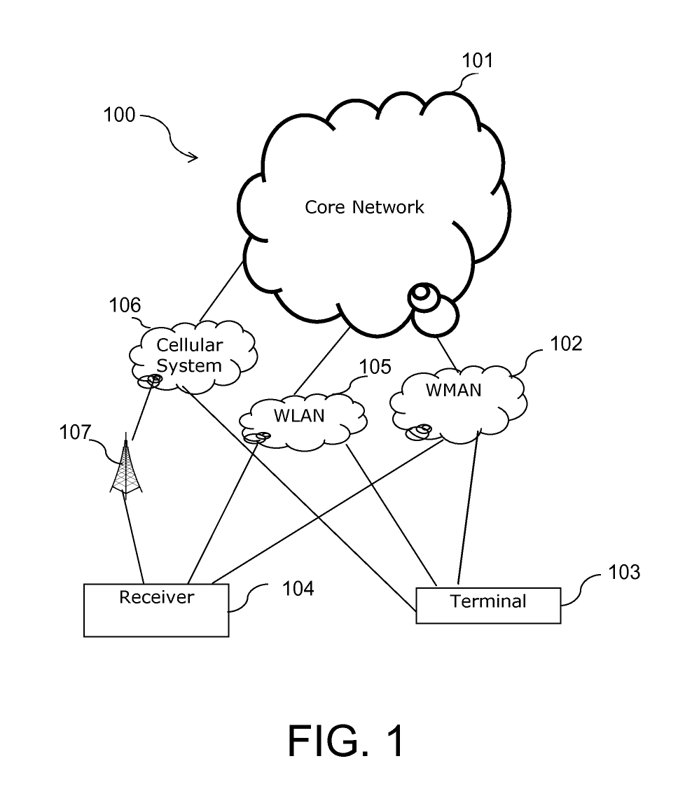

FIG. 1 shows the architecture 100 illustrating entities comprised in the systems for communicating an information from a sender to a receiver; the sender being for example a base station 107 in a cellular system 106, or an access point in a wireless local area network, or in a wireless metropolitan area network or a terminal in a wireless personal area network (e.g. Bluetooth); and a receiver being a terminal connected to at least one of the above networks. The sender may also be located in the core network.

Examples of communication systems relevant to the present invention are A wired system, a cable network (e.g. DSL, ADSL network), a power line network, a photonic or optical network (e.g. fiber to the x FFTx, FFTN, FFTC, FFTB, FFTH, 802.8, 10 Gigabit Ethernet, Gigabit Ethernet, Synchronous Digital Hierarchy, Synchronous Optical Networking), a Local Area network (e.g. Ethernet, 802.3, 802.2, 802.1, 802.4, 802.5, Token Ring), a metropolitan area network (e.g. 802-2001, 802.6, ATM), a cellular system (e.g. 2G, 3G, 4G, GSM, GPRS, EDGE, UMTS, CDMA2000, HSPA, LTE, NGN), a wireless local area network (e.g. Wifi, 802.11, HiperLAN), a wireless metropolitan area network (e.g. 802.16 WiMAX, HiperMAN), a mobile broadband wireless access network (e.g. 802.20), a wireless personal area network (e.g. Bluetooth, Infrared, 802.11, 802.15, UWB, Zigbee), a high attitude platform network, a satellite network (e.g. GPS, GNSS, DVB), a broadcasting network (e.g. television network, digital television system), a Personal Handy-phone System (PHS) network, a point-to-point network, an ad hoc network, a multi-hop ad hoc network, a peer-to-peer network, a sensor network (e.g. RFID system, near-field communication network), a private network, a virtual network, a cooperative communication network, a relay network, a cognitive radio network, a grid computing network or any combination thereof.

The method for communicating intended information between a sender and at least one receiver in a communication system comprises:
a) providing a plurality of elements to be sent from the sender to the receiver, the plurality of elements being in a first order;
b) sending to the receiver the elements in a second order, the second order representing the intended information;
c) receiving the plurality of elements;
d) determining whether an order in which the elements have been received is different from the first order;
e) if the order in which the elements have been received is different from the first order, determining an information based on the order in which the elements have been received;
f) if the order in which the elements have been received is the second order, the information determined is the intended information.

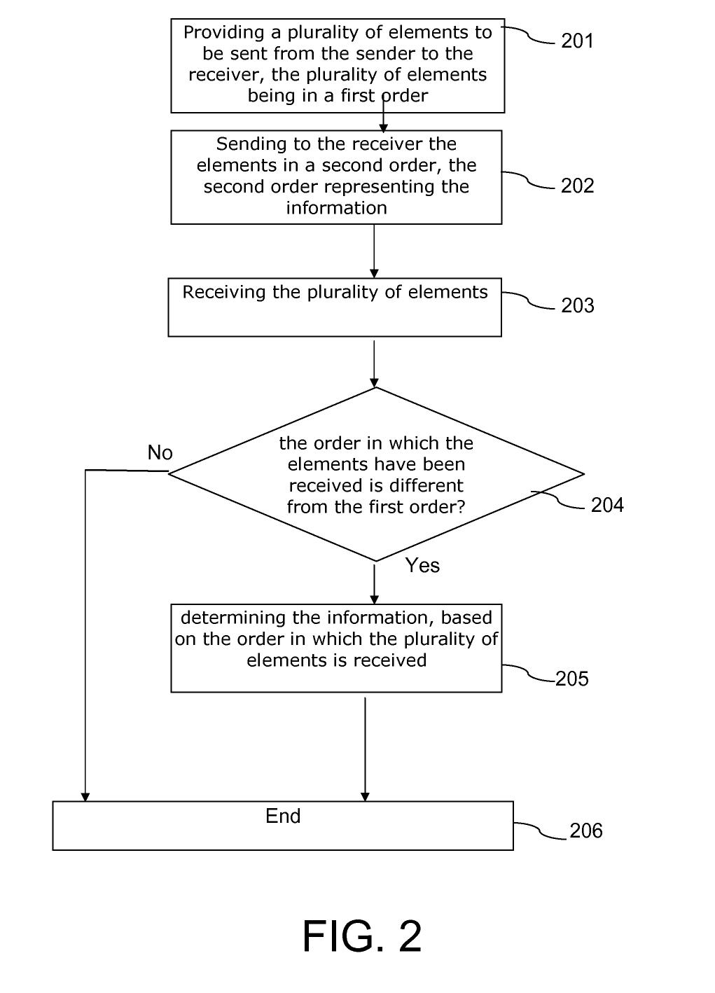

FIG. 2 is a flowchart illustrating an exemplary implementation of the method of the invention. At step 201 the sender is provided with a plurality of elements to be sent from the sender to the receiver, the plurality of elements being in a first order. At step 202, the sender sends to the receiver the elements in a second order, the second order representing the information. At step 203, the receiver receives the plurality of elements from the sender. At step 204, a process determines whether an order in which the elements have been received is different from the first order. If the order in which the elements have been received is different from the first order, step 205 determines the information based on the order in which the elements have been received and then the process ends at step 206. If the order in which the elements have been received is not different from the first order, the process proceeds to step 206 where it ends.

If there is no first order present in the communication system, the present invention generates a first order representing the information to be communicated from the sender to the receiver and sends the elements in the first order. As the receiver expects no order, the receiver is able to determine that an order is present in the elements received and determines the order as being the first order to finally retrieve the information carried by the first order.

The invention allows for generating multiple orders i.e. n+1th order if the communication system has a nth order, with n being an non-zero integer. For example, if the elements are arranged in a nth (e.g. second) order, then according to the invention, they will be sent in a n+1th (e.g. third) order representing the intended information to be communicated from sender to receiver, thus allowing the receiver to obtain the intended information.

In an embodiment of the invention, to obtain the second order representing the information, the invention can generate a sequence representing an ordered arrangement of a plurality of elements in a set, the sequence thus representing information to be communicated from the sender to the receiver. For example, the sequence can be a permutation of the plurality of elements, or a combination of the plurality of elements.

A frame to be a structure of duration of F packets is firstly defined. Each frame can be seen as one symbol used for the present invention, i.e. one array of packets for the original or first communication system represents only a single transmission in terms of the present invention.

It is firstly assumed that each frame A has exactly H packets to send, where 0<H<F. The amount of information contained in a single symbol is fixed to log 2 (F!/(F−H)!). If H is constant for all frames, then the amount of information that can be sent by each frame through the present invention is fixed.

Consider a communication system in which there is a link between A and B. The nodes A and B are running a legacy communication protocol in which the packets are numbered by using 4 bits, i.e. each packet is marked with a number from 0 to 15. It is said that this legacy communication protocol belongs to a primary communication system, i.e. the communication system that uses transfers the data carried in the packets. Assume that each packet carries 50 bits for the other user. A collects 16 packets and transmits them to B. The protocol requires to send them in the order in which they are marked: 0, 1, 2, . . . .

In that case, B can decode them as they arrive. However, since they are numbered, even if they arrive out of order, B will decode them correctly. For this simple scenario, the main idea of the invention disclosure can be stated as follows: the order in which A sends the packets to B is determined according to a sequence representing an additional information that A needs to send to B. Note that in this case there are 16! possible ways to order the packets from A to B, each way representing one permutation. This means that the ordering of the packets according to the invention can transfer: log 2(16!)≈44.25 [bits] additional bits of information from A to B.

Practically, this means that, before sending the 16 packets, A can take 44 bits and determine the order in which these packets will be sent. Note that, for simplicity, 0.25 bits have been “sacrificed” in this example. In principle, 4 consecutive transmissions of groups of 16 packets could be grouped and thus have opportunity to send 177=4×44,25 bits. In that case, the 177 bits have to be used to determine all the four permutations (each of length 16). From the implementation point of view, besides the original communication protocol, A should have a module that orders the packets according to the data it wants to send and B should have a module that will extract the data encoded in the packet order.

Hence, the legacy communication protocol need not be significantly changed, but only overlaid by using the modules that read/write in the order of the packets. The following terminology can be found convenient. The primary communication systems use the data contained in the packets. The communication that uses permutations by reordering of the data packets belonging to the primary system, can be termed secondary communication system.

In the previous example, perhaps the 16 bits are needed if this communication protocol is used over a large network with routers, such that the packets might arrive at the destination at a random, unpredictable order. However, such a primary (legacy) communication system might be widely spread and cheap, such that it can often be used in scenarios where the order of packet arrivals at the destination is more predictable or controllable. In short, our method of communication makes use of the protocol information that has been implemented to support a more general communication system, but that protocol information has no real value if not used according to the invention.

The method according to the invention enables communication of data by combinatorial arranging of the elements and, in particular, packets, headers that describe the user data, channel allocations and so on.

According to the invention, the information communicated from the sender to the at least one receiver can be used to coordinate a usage of a spectrum among a plurality of terminals, for example terminals operating in unlicensed band. Such a coordination may take place in Wireless LAN (WLAN), WiMAX, Bluetooth, Zig bee, a cellular system, UMTS, DVB, a cognitive radio system, or any other system cited above.

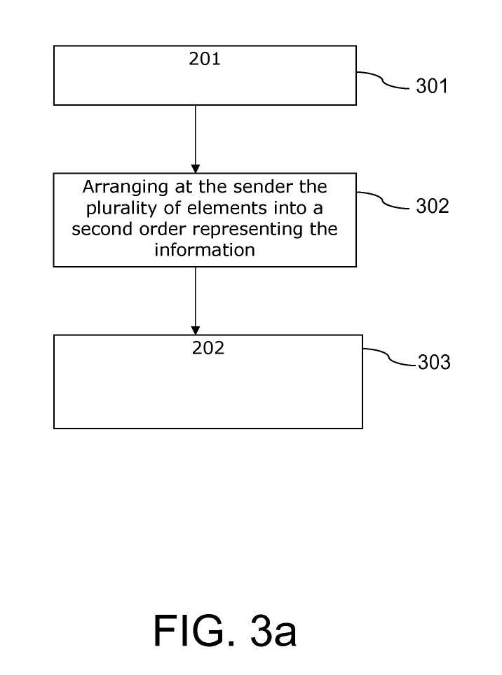

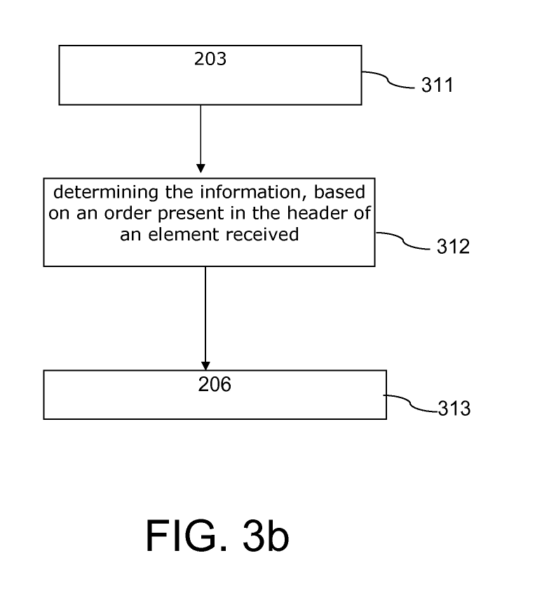

FIG. 3a shows a flowchart illustrating another exemplary implementation of the method of the invention wherein from step 201 (step 301) the method proceeds to arranging at the sender the plurality of elements into a second order representing the information (step 302) and then continues with step 203 of the method of FIG. 2 (step 303).

In yet another embodiment, at the sender the plurality of elements are arranged into a second order representing the information by an encoding technique.

In another embodiment the first order is present in a first system and the second order or order of received elements is used by a second system. Also the present invention covers the case where the first order is present in a first system and where the second order is implemented by the first system and the first and second order are used by a second system

In another embodiment, the arrangement of the plurality of elements sent to a receiver, i.e. the second order, is a code for correcting an error present in the plurality of elements received.

FIG. 3b shows a flowchart illustrating another exemplary implementation of the method according to the invention wherein from step 203 (step 311) the method proceeds to determining the information, based on an information or an order present in the header of an element received (step 312) and then continues with step 206 of the method of FIG. 2 (step 313).

In another embodiment, the method further comprises arranging a plurality of resources allocated to a plurality of terminals in a second order representing the information.

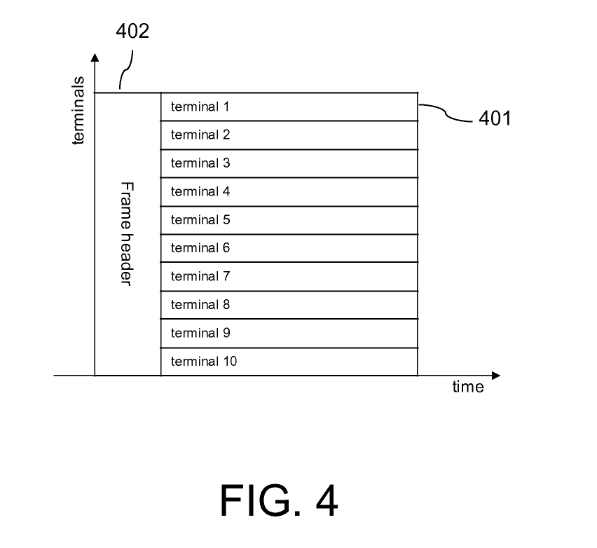

FIG. 4 shows for example an arrangement of a plurality of terminals 401 over a plurality of channels in a second order representing the information to be communicated to the at least one receiver. A receiver receiving at least one of the frame headers 402 can determine the information that the sender wants to communicate to it from how the assignment of the channel to the terminals is arranged.

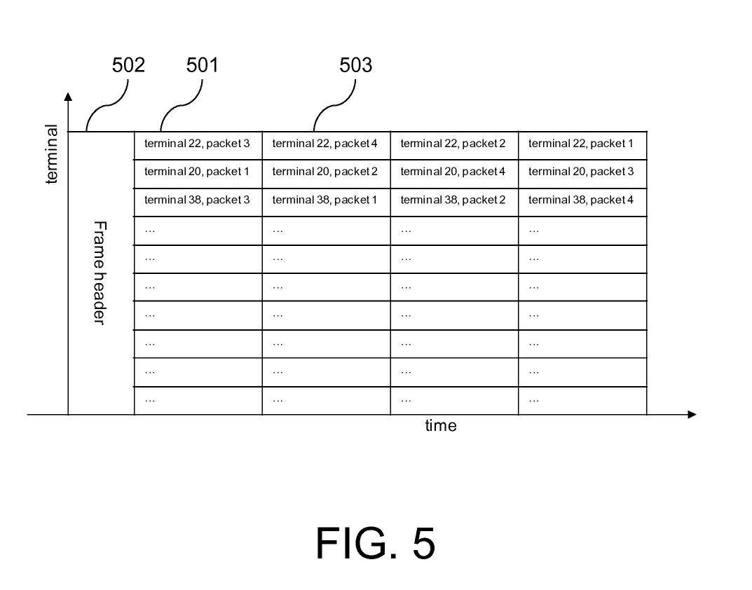

FIG. 5 shows another example of an arrangement of a plurality of channel assigned to a plurality of terminals and packets 501 and 503 in a second order representing the information to be communicated to the at least one receiver. A receiver receiving at least one of the frame headers 502 can determine the information that the sender wants to communicate to it from how the assignment of the channels to the terminals and packets is arranged.

The arrangement may also be performed over a plurality of channel codes assigned to a plurality of terminals in a second order representing the information to be communicated to the at least one receiver. This example illustrates how such arrangement according to the invention can be performed in UMTS, HSDPA and other 3G systems.

In this application, a primary system could also be termed a first system, a secondary system could also be termed a second system and a user is equivalent to or could be termed a terminal and vice versa.

Consider a primary or first system in which a Base Station (BS) is serving users in its range and uses a legacy communication protocol (LCP). Each user has an identifier Uj. The system may have M channels over which it can transmit simultaneously. Before doing the actual data transmission, the system uses a designated channel where the system announces how the users or terminals are allocated in the channels. If a single user is allocated at each channel and each channel has a different user, then this channel allocation announcement is a permutation of length M. Therefore, the BS can send log 2(M!) bits in each announcement of the user allocation. This announcement will be referred to as frame header.

Here is an example of usage scenario for such a LCP. Consider a system with 10 channels. The frame header is sent on a common channel, which is received by all the users. One option is that a predefined channel from those 10 channels is used for the frame header. Another option is to bundle all the 10 channels and spread the protocol information over all of them. The latter case can occur, for example, in systems based on Orthogonal Frequency division Multiplexing (OFDM). This is depicted FIG. 4. Note that it is a commonly used method in communication systems (e.g. WiMax), as the information contained in the frame header should be reliably detected by all the users in the network.

Furthermore, the methods for reliable transfer used in the header are usually very robust and based on a lot of redundancy, which implies that they are using error-control techniques that do not require a very sophisticated demodulator and decoder. On the other hand, the data sent to the users after the frame header is announced, might use very complex modulation/coding combinations, which are reflected in a more complex transceiver design for the users of the system.

Now, assume that we want to deploy sensors/actuators in the area that is covered by the base station, but the sensors/actuators only include simple transceivers. Using the idea of this invention, it is possible to proceed as follows. The sensors should have transceivers that do not need to comply with the primary system in a sense to support the full legacy communication protocol, but are only able to decode the frame header. Then the BS may use the presented method of transmitting information to the sensors without disturbing the legacy terminals and using simple transceivers for the new devices. Namely, the implementation of the proposed communication method can be done completely in software, without any hardware changes to the legacy communication protocol.

It is firstly assumed that the set of 10 users that will be selected in a particular frame is decided by a scheduler from the primary communication system and our communication method cannot influence it. Consider FIG. 4 or 5. In the first frame, the 10 selected users are have the following user identifiers Ui: 47, 11, 30, 24, 44, 38, 22, 3, 40, 20. Then those users can be ordered and a relative user identifier can be uniquely assigned—for example, the user 3 will have relative identifier 1, the user 11, will have a relative identifier 2, . . . etc and the user 47 will have a relative identifier 10. Note that the relative identifiers do not need to be sent in the frame header, as they are uniquely determined from the absolute identifiers of the scheduled users. For example, if the BS needs to send the information that corresponds to the permutation 4, 3, 7, . . . , then it will put user 22 in channel 1, user 20 in channel 2, user 38 in channel 3, etc. Note that the set of users selected in the second frame is different, but in this example, the users in frame 2 are ordered in a way that the second frame carries identical information with the first frame (i.e. the permutation created is 4, 3, 7, . . . ). By assuming that the frame length is 10 ms, then the throughput offered by the present invention is: R=log 2(10!)/10=2.179[kbps].

On the other hand, if it is allowed for the purpose of the present invention to select the set of scheduled users, then we can increase the data rate of present invention. This is because the number of valid signals in the frame header increases from 10! to 50!/40!, such that the throughput becomes: R=log 2(50!/40!)/10≈5.5409[kbps].

This scenario can be further extended if the possibility that the data transmission of each user in each channel consists of several packets is considered. In that case, it will require the new devices to be able to decode these packet headers, in addition to the capability to decode the frame header. Assume that each user sends 4 packets in the channel, suitably numbered. FIG. 4 shows that, by using the user identities and the packet ordering, the number of states that can be signalled for the purpose of present invention is 10!*(4!/10, which will bring the data rate to: R=log 2(10!*(4!)̂10)/10=6.7641[kbps].

If, in addition, with the present invention it is allowed to determine the set of scheduled users, then R=log 2(50!/40!*(4!)̂10)/10=10.09[kbps].

The data rates achieved by the present invention are significant for systems with modest data rate requirements, such as sensor/actuator networks.

The present invention can be applied to all types of resource allocations to terminals such as: OFDM, OTDM, TDMA, FDMA, CDMA, WCDMA, FDM, TDM, OFDMA, FHSS, DSSS.

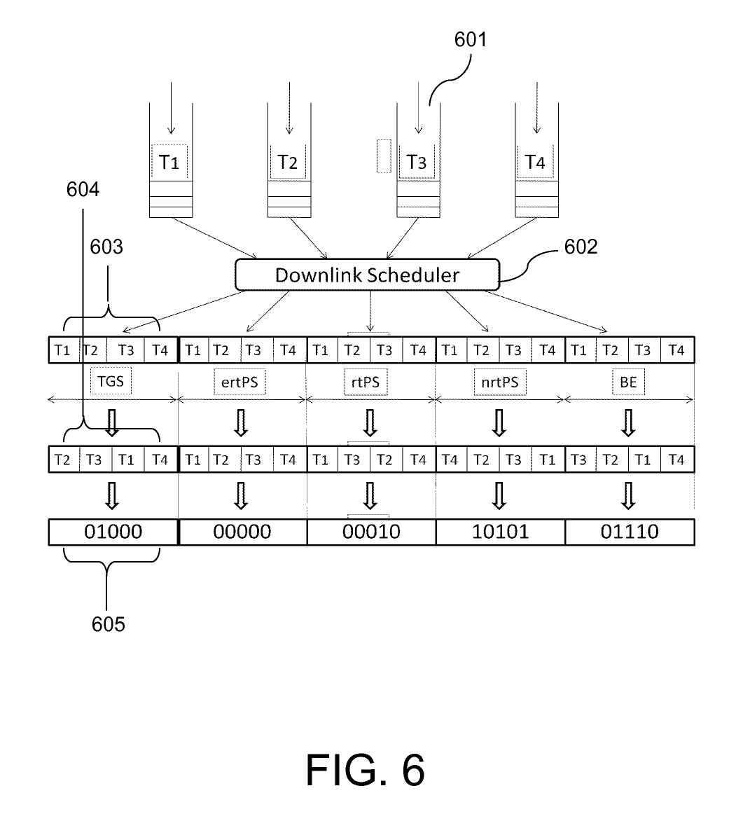

FIG. 6 shows another example of an arrangement of a plurality of terminals over available downlink channels from a first order 603 to a second order 604. The arrangement results in a sequence 605 which represents the information to be communicated from the sender to the receiver. This example illustrates how such arrangement according to the invention can be performed in WiMAX.

In Wimax, a base station (BS) schedules downlink traffic for the subscribe stations (SS). The traffic in Wimax is classiffied in service classes according to priority as Unsolicited Grant Services (UGS), extended real time Polling Service (ertPS), real time Polling Service (rtPS), non real time Polling Service (nrtPS) and Best Effort (BE), respectively. The scheduling for the downlink can be performed per service class instead of scheduling packets subscriber (user) wise. In this context, packets belonging to the same service class (and in general to different subscribers) can be grouped together and sent within a certain time frame.

However, the rearrangement (permutation) of the packets belonging to the different users within the frame can be arbitrary. Therefore, additional information can be sent by allowing different permutations of packets. This is depicted on FIG. 6. The packets are first segregated into queues meant for particular users. Within the users' queues, the packets are again segregated into service type queues. The downlink scheduler groups the packets according to service type, irrespective of its destination. During transmission the packets are sent out in the order, as specified in the frame. This falls in the framework that this invention defines.

An example with 4 users is given on FIG. 6. For example, let U1; U3; U2; U4 be one arrangement of the 4 users having packets from the rtPS class. This corresponds to the permutation 0; 2; 1; 3. Since all permutations can be numbered from 0 to 4!−1=23, this sequence can be mapped to a sequence of 5 bits. The same holds for all service classes. On average, log 2(4!)=4.585 bits of information can be sent with each service class.

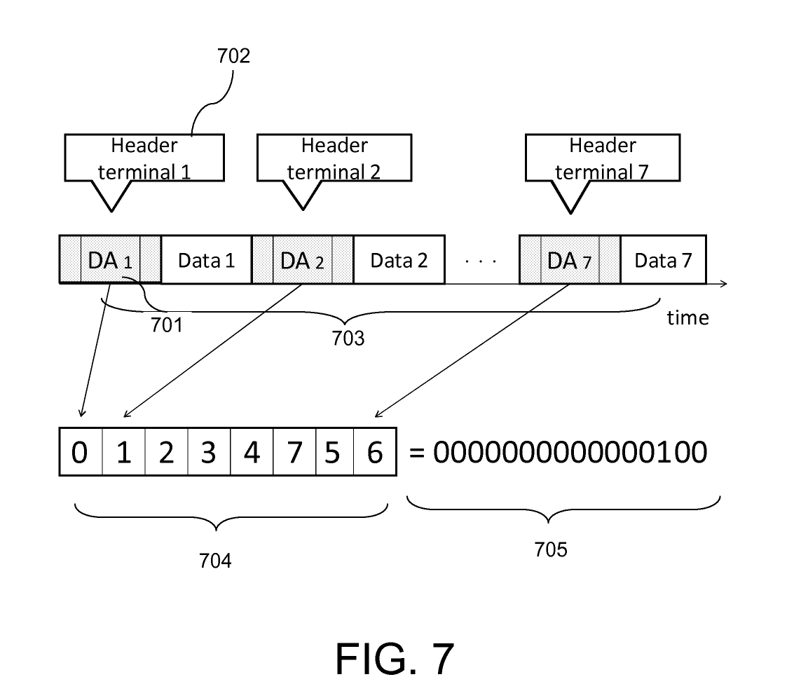

FIG. 7 shows another example of an arrangement of a plurality of terminals' data packets over a channel. Packets such as 701 with a header 702 are ordered in a permutation from a first order 703 to a second order 704 representing the information 705 that the sender wants to communicate to the receiver. In this example, it is shown how the invention is performed in WLAN using a permutation of data packets ordered according to the terminal's MAC addresses.

In WLAN, the Access Point (AP) can perform scheduling of traffic for different users. Here, two ways of sending additional information are possible.

In one scenario, the Access Point can group packets belonging to different users. The additional information is provided by the relative arrangement of the packets within one group based on the physical (MAC) addresses.

For example if N users can be grouped together, what is needed is that the sequence of MAC addresses is mapped to an ordered sequence (permutation) of numbers between 0 and N−1. The permutations are then numbered based on the relative order within the group. The number of permutations is N!. An example is shown on FIG. 5, where the sequence of 8 destination physical addresses DA1;DA2;DA3;DA4;DA5;DA8;DA6;DA7 is converted into the sequence of bits 0000000000000100 according to the number of the permutation 0; 1; 2; 3; 4; 7; 5; 6 in the set of 8! permutations.

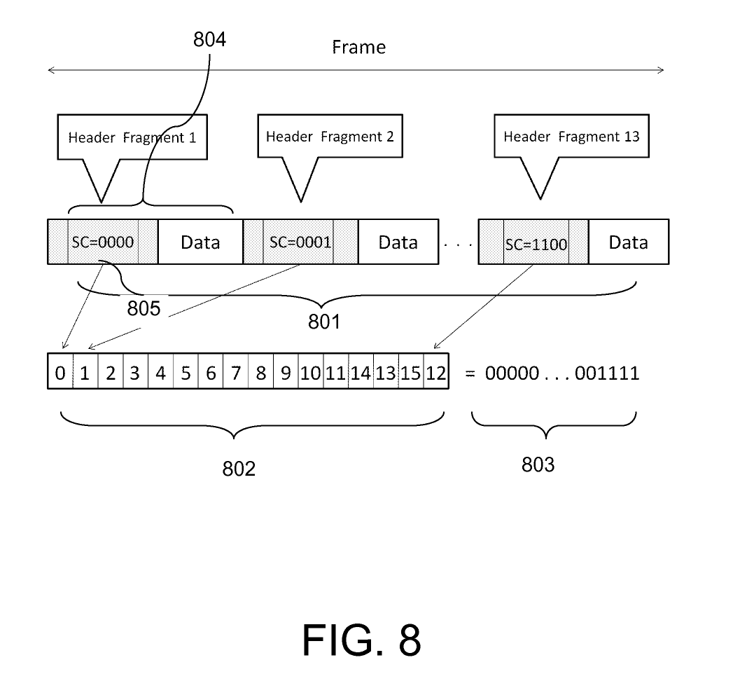

FIG. 8 shows a similar example as in FIG. 7, except that the arrangement of the plurality of data packets 804 over a channel from first order 801 to second order 802 is performed according to the Sequence Control field 805 available in WLAN to convey information 803 to a receiver (overhearing or not the transmission of the plurality of data packets according to the arrangement).

In a more sophisticated scheduling scheme in WLANs, scheduling may be performed having on mind some QoS requirements. In that case, it may be reasonable to group the users belonging to a same class (having same priority, similar as in the WIMAX example). Since within one class there is a freedom in the ordering of the packets, this can be used to transmit information in the same way described above.

If it is not possible to group the users for some reason (delay constraints for example) it is still possible to perform the invention. Namely, packets belonging to one user can be reordered according to the fragment number in the Sequence Control (SC) field used for fragmentation of data, as shown on FIG. 8. The Sequence Control (SC) field is used to represent the order of the different fragments belonging to the same frame. In the SC field, 4 bits are reserved for the fragment number, meaning that up to 16 fragments are allowed. This, on the other hand, allows for sending log 2(16!)≈44.25 additional bits of information, based on the arrangement of fragments.

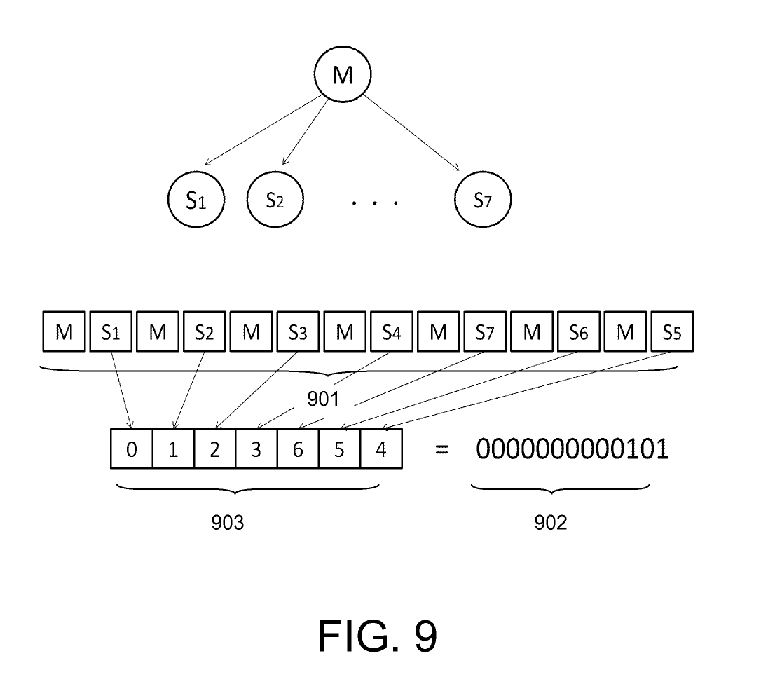

FIG. 9 shows an example an arrangement of a plurality of terminals 901 over a channel, the arrangement 901 in a sequence 903 representing information 902. In this example, it is shown how the invention is performed in Bluetooth using a permutation of terminals over a channel.

Bluetooth uses a piconet structure for short range communication. A piconet is an ad-hoc network formed by at most eight Bluetooth enabled devices, one of which acts as the master and the remaining ones as slaves. The master of the piconet is responsible for scheduling for communication with the slaves. If the members of a piconet use Asynchronous Connectionless Links (ACL) for communication between them, then additional information can be send.

Namely, the master can poll the slaves (up to seven) in an, in general, arbitrary way. Since all slaves “listen” in order to see if they are addressed, the ordering of the slaves in the sequence determined by the master, can carry additional information of up to log 2(7!)≈12.2992 bits. The order in which the slaves are polled is a permutation which carries the information. An example is depicted on FIG. 7. If it is wanted to transmit the bit sequence 0000000000101, the slaves will be polled in the order 51; S2; S3; S4; S7; S6; S5. This corresponds to the permutation 0; 1; 2; 3; 6; 5; 4.

The method according to the invention further comprising arranging a plurality of resources allocated to a plurality of terminals in a second order representing the information. A resource is a channel, a code, a frequency, a time interval or a combination thereof.

For example, the method may comprise arranging a plurality of channel codes assigned to a plurality of terminals in a second order representing the information to be communicated to the receiver. The plurality of channel codes assigned to a plurality of terminals is a plurality of channel codes for cellular systems.

For example, the arrangement of the plurality of elements into the second order can be an encoding technique.

Consider a system based on spread spectrum communication and time division multiplexing, where a set of users is served in one time frame using channelization codes. It is assumed that the spreading factor is n, meaning that n channelization codes exist. The number of users which can be served in this time frame is the number of channelization codes available, and is determined by the available system resources. It is assumed that in the next time frame used for transmission, k out of n channelization codes (1<k<n) are available, meaning that k users can be served. Now suppose that there is freedom in the decision of which k codes will be chosen. This is realistic, since the channelization codes are symmetric in the sense that no codes are favored. Obviously, having the freedom of the choice of the k codes, this can be done in (n, k) combination ways.

This, on the other hand, allows for transmitting of additional log 2 (n,k) bits in the time frame. On average, the number of bits which can be transmitted depends on the number channelization codes k allowed in each frame. An example is a system with spread factor of 10 and a time frame of 1 ms. Further, for simplicity, it is assumed that the probability that k codes are available is p= 1/10 each 1<k<10. Then the average rate possible to transmit with this scheme is R=( 1/10)>Σ(k=1,10) log 2(10,k) bits=frame=5.48 [kbps]

Conceptually, this idea can be further extended and allow that, besides the channelization codes, there is also freedom in the choice of the users that are going to be served in the next frame. If, for example, N users and k channelization codes are available in the next time frame, the k users to be served in (N,k) ways can be chosen. This, together with the freedom of choice of the k codes, gives a rate of log 2 [(N, k)*(n, k)] bits/frame. If the same example as before is used with N=20 users, n=10 channelization codes and probability p= 1/10 that k codes are allowed, for the rate R=( 1/10)>(k=1,10) log 2[(20,k)*(10,k)]=18.63 bits/frame=18.63 [kbps] is obtained.

For UMTS with HSDPA:

High-Speed Downlink Packet Access (HSDPA) is a 3G (third generation) mobile telephony communications protocol, which allows networks based on Universal Mobile Telecommunications System (UMTS) to have higher data transfer speeds and capacity. With HSDPA, the High Speed Downlink Shared Channel (HS-DSCH) in the UMTS specification is shared between users using scheduling to make the best use of available radio conditions. Data is sent to users in time frames of 2 ms. The base station decides which users will be sent data on the next 2 ms frame. The users within this time frame are separated with channelization codes. The amount of the channelization codes, and thus network bandwidth, allocated to HSDPA users is determined by the network. This allocation represents a trade-off between bandwidth allocated for HSDPA users, versus that for voice and non-HSDPA data users. The allocation is in units of channelization codes for spreading factor 16, of which 16 exist and up to 15 can be allocated to HSDPA.

When the base station decides which users will receive data on the next frame, it also decides which channelization codes will be used for each user. This information is sent to the user devices over one or more HSDPA “scheduling channels”. These channels are not part of the HSDPA allocation previously mentioned, but are allocated separately. Thus, for a given 2 ms frame, data may be sent to a number of users simultaneously, using different channelization codes. The maximum number of users to receive data on a given 2 ms frame is determined by the number of allocated channelization codes. This scenario fits directly the system described above.

It is assumed that, for example, 30 users are active. In each 2 ms frame, up to 15 users will be served, according to the resources available. On average, it is assumed that the probability p that k codes (1=<k=<15) are available is the same for all k, p= 1/15. Only the free choice of the channelization codes will give an additional rate of R=( 1/15)>(k=1,15) log 2(15,k)=8.85 bits/frame=4.42 [kbps]. If the k users in each frame are allowed to be chosen arbitrarily, the additional available rate is R=( 1/15)>(k=1,15) log 2[(30,k)*(15,k)]=28.98 bits/frame=14.49 [kbps].

FIG. 10 shows an application of the present invention in a cognitive radio system where a primary Base Station 1004 has users (primary terminals PT1 1001; PT2 1002; PT3 1003) that are at the edge and cannot send data to them efficiently. Two cognitive nodes C1 1005 and C2 1006 can relay data to the terminals of the primary (legacy) system 1001-1003. In this embodiment, the present invention is used to maintain a communication link between C1 1005 and C2 1006. The cognitive nodes 1005 and 1006 agree to relay packets for the primary system in the following way: First 1005 relays K packets to the primary terminals 1001-1003 while 1006 receives this relay transmission, then the 1006 acts as a relay for the next K packets, then again 1005 and so on. When relaying the K packets, the cognitive node can permute them in a way to send message to the other cognitive relay, either by using the ordering number of the packet or by using the user identifier (provided that all the K packets are intended for K different users).

When additional, usually small, communication capacity should be achieved by using an existing system, then the usual way to proceed is to use some of the unused bits in the legacy communication protocol (LCP) of the original system. That is, the protocols are often designed to leave some bits “for future use”. With the proposed method of the present invention, it is not needed to revert to those bits and do not incur any change in the LCP, but still succeed in sending additional information.

One very important application of such signalling is in the area of cognitive radio (CR). Cognitive radio also deals with the terminology of primary and secondary communication system, but related to the spectrum usage. A wireless network based on cognitive radio is allowed to reuse the frequency spectrum which is licensed to another system, called a primary system user. Hence, the cognitive radio appears as a secondary user of the spectrum. The secondary wireless system is allowed to use certain frequency spectrum at a certain spatial point and during a certain time, provided that it does not cause adverse interference to the communication within the primary system.

Recently, one of the most critical issues that have been identified in cognitive radio systems is the design of cognitive Pilot Channel (CPC). The main goal of the CPC is to support reconfiguration management in heterogeneous wireless environment between network and user terminals. CPC can be seen as a radio channel which conveys the elements of necessary information facilitating the operations of Cognitive Radio Systems. There are two ways to deploy CPC out-of-band (by defining a dedicated frequency channel) or in-band (where the resources of an existing system are utilized). Clearly, the present invention can be used to convey in-band signalling information related to CPC.

Another interesting usage related to cognitive radio is the operation in “white spaces” of the spectrum in 700 MHz. These white spaces include, but are not limited to, 180 MHz of available bandwidth from channel 21 (512 MHz) to 51 (698 MHz), with the exception of channel 37. On Nov. 4, 2008, the FCC issued a historic ruling permitting the use of unlicensed devices in these white spaces. In its ruling the FCC imposed an important requirement that white space wireless devices must not interfere with incumbents, including TV broadcasts and wireless microphone transmissions.

The most critical issue is that the cognitive radios in white space do not interfere with the reception at the digital TV receivers. Since the digital TV standards, such as DVB-T or DVB-H are utilizing packetized transmission, combinatorial ordering of those packets can be used by the TV broadcasting station to convey control information to the cognitive radios that can receive its signal. Thus, cognitive radio will need to have capability to decode these signals. The actual way of implementing the present invention can be by reordering the encapsulated IP packets or by using the digital multiplexing applied in digital TV systems.

Another interesting application refers to an alternative way to implement cognitive radio. This example makes the direct relation between the primary/secondary terminology used for the present invention and the primary/secondary terminology used in cognitive radio.

The information sent by permuting the data packets or users of a certain legacy communication protocol (LCP) can certainly be decoded by the devices that use that LCP. However, note that in order to decode the information sent by the present invention, a device does not need to have a full implementation of the LCP, but it should rather be only able to decode the control information in packet and frame headers. This can make a significant difference, as the following example shows. In the emerging broadband systems (e.g. WiMAX), control information in the frame header is encoded by using modulation and robust encoding which are much simple compared to the sophisticated modulation/coding schemes that can be used by the same system to transmit data at higher rates.

An option is to have a device with an optimized hardware to decode only the relevant headers of one LCP. It may also have implementation of suitable hardware that can decode the relevant headers and control information of the protocols for different systems. Another option is to have an implementation based on Software-Defined Radio (SDR), which can be utilized to decode headers (and thus the information sent by the present invention) for different systems. For example, a cognitive radio that needs to read control information sent through the Digital TV (DTV) broadcasting stations, may have only a module that decodes the relevant headers used in DTV transmission, without decoding the complete TV signal.

Sending the plurality of elements according to the invention, i.e. into a second order representing the information provides to the communication system additional in-band signaling capacity.

The invention can be implemented by means of hardware, software, firmware or any combination of these. The invention or some of the features thereof can also be implemented as software running on one or more data processors and/or digital signal processors.

The individual elements of an embodiment of the invention may be physically, functionally and logically implemented in any suitable way such as in a single unit, in a plurality of units or as part of separate functional units. The invention may be implemented in a single unit, or be both physically and functionally distributed between different units and processors.

Although the present invention has been described in connection with the specified embodiments, it should not be construed as being in any way limited to the presented examples. The scope of the present invention is to be interpreted in the light of the accompanying claim set. In the context of the claims, the terms “comprising” or “comprises” do not exclude other possible elements or steps. Also, the mentioning of references such as “a” or “an” etc. should not be construed as excluding a plurality. The use of reference signs in the claims with respect to elements indicated in the figures shall also not be construed as limiting the scope of the invention. Furthermore, individual features mentioned in different claims, may possibly be advantageously combined, and the mentioning of these features in different claims does not exclude that a combination of features is not possible and advantageous.

The terminology of primary/secondary communication system bears resemblance to the concepts used in cognitive radio. A wireless network based on cognitive radio (CR) is allowed to reuse the frequency spectrum which is licensed to another system, called a primary system user. The usual view on cognitive radios is that the primary (incumbent) systems operate with certain interference margin, such that they can receive additional interference from the secondary (cognitive) users in the same spectrum. On the other hand, the data sent within the secondary systems increases the overall spectral efficiency. Hence, the margin of suboptimal operation of the incumbent is converted into a secondary data rate. Following this line of thought, secondary communication through protocol coding can be seen as a form of cognitive radio: a secondary communication by reordering of primary user resources is possible since the primary protocol inherently tolerates certain delay in serving the users. In this case, this delay margin is converted into a secondary data rate. This is clearly illustrated in the example in FIG. 10 where two cognitive devices, C 1 and C 2, perform relaying on behalf of a primary BS to help the reception at the primary terminals (PTs). The cognitive nodes agree to relay packets for the primary system in the following way: First C 1 relays M packets to the primary terminals while C 2 receives this relay transmission, then the C 2 acts as a relay for the next M packets, then again C 1, and so on. When relaying the M packets, the cognitive node can permute them in a way to send message to the other cognitive relay, either by using the ordering number of the packet or by using the user identifier (provided that the M packets are intended for M different users). This is de facto cognitive radio, as C 1 and C 2 communicate in the same spectrum used by the primary system. If the tolerable delay in the primary system is larger, then M is larger and more information can be sent through the secondary channel.

Several important features can be noted for this class of communication techniques. First, for delay-constrained systems, the data rate offered by the secondary communication is relatively low, so it is hard to argue that this method brings a significant rate advantage e.g. for broadband wireless systems. Second, the achievable secondary data rate depends on the current load (traffic, number of users) in the primary system. For example, the best secondary rate for the system on FIG. 10 is obtained when each channel can be allocated to a different, but arbitrary user. If there is a single primary user in the system, the secondary capacity is decreased. Interestingly, this is somewhat desirable—it is when the primary system is fully loaded that we need additional capacity; otherwise we can use the original system to send data.

The third feature is related to the complexity of the devices that can decode the information over the secondary channel. It should be noted that the new secondary devices, depicted on FIG. 10, do not need to include implementation of the full protocol stack, but rather only to decode the headers of the primary system. This brings opportunity to have low-complexity, low-power reception at the secondary channel. The complexity can further be lowered by not requiring to decode the packet from the secondary communication. In that case, protocol coding reckons only with two transmission states: packet transmitted and slot idle. In other words, “no packet” is a valid secondary information. For example, let Alice and Bob communicate by organizing the packets into frames of size F and assume that Alice sends only two packets in each frame, such that F−2 slots of the frame are empty. Then the amount of information that Alice can send is

$${log}_{2} \frac{F ( F - 1 )}{2} \approx 2 {log}_{2} F [ bits \text{/} slot ]$$

by using protocol coding. Note that Carol, that decodes only secondary information, needs only to detect presence/absence of a packet, but not its content, which significantly lowers the complexity.

Header compression may appear as a competitor to the proposed approach of secondary communication, as it works in a somewhat opposite way: tries to compress the overhead whenever the actual communication scenario allows it. However, header compression is not completely canceling the opportunity for secondary communication, and vice versa. For the example above header compression would aim to compress the MAC-layer identifiers, but in the end all the users have to be differentiable and the opportunity for secondary communication arises from the fact that the scheduling method in the primary system allows reallocation of the users. Conversely, if there are only M users in the system and the MAC addresses use more than log₂ M bits, then header compression is, in principle, possible, while those extra bits cannot be used to improve the secondary rate, as they do not help to increase the number of possible orderings.

An interesting dividend of the concept of secondary communication is that it can be used to assess the performance margin that a certain primary protocol/system has with respect to the optimal performance. Intuitively, if in a given scenario the secondary capacity is non-zero, then the operation of the primary system is not optimal

With the features listed above, there can be several applications of the secondary communication channel defined by protocol coding. In general, we can expect that the secondary channel can deliver low data rates, but the delivered bits are usually much more reliable than the “normal” data bits, because the secondary channel utilizes the transmission of the overhead/control data, which is usually robustly encoded. This hints that a generic application of the secondary communication is sending of additional control data.

The first usage of such a control data can be as expanded “future use” bits. Recall that in many specified/standardized protocols there are unspecified, free bits left in the header for future use. Protocol coding can be seen as a way to unleash “hidden” future use bits in the protocol, which may become indispensable if, at some point of the protocol evolution, additional bits are needed, beyond the ones originally specified for future use.

Another usage can be signaling for efficient spectrum sharing. In the evolving paradigm of cognitive radio and dynamic spectrum access, the main concern is the interference that the cognitive (secondary) users are causing to the incumbent (primary) user. Therefore the secondary users should run spectrum sensing algorithms in order to assess which spectrum resource is available for communication at a given time instant. The spectrum sensing process may be significantly improved by using a Cognitive Pilot Channel (CPC), which conveys the necessary information to let the terminal to obtain knowledge of the status of radio spectrum. We argue that protocol coding inherently introduces a possibility to define an in-band CPC. Consider again the scenario on FIG. 1 and assume that, besides the module that can decode the information sent by the base station over the secondary channel, the secondary devices have an additional, cognitive, radio interface to communicate with each other. Then the primary base station can dynamically send information about the available resources for cognitive radio, and this information can be decoded in a range that is larger than the nominal communication range of the primary system.

There is an interesting observation if we consider the primary system to be a digital TV broadcaster: in principle, the suggested way of protocol coding can be applied by reordering the packets of the TV signals, which practically empowers the TV broadcast tower to dynamically control the usage of the spectrum by cognitive users. To the best of our knowledge, such a possibility to turn the TV broadcasters from victims into controllers of a cognitive radio has not been observed before.

In the emerging paradigm of M2M communication it is expected that the cellular networks will have to embrace a large number of low-cost, low-power devices. Such devices have not originally planned to be members of the broadband cellular network and they feature traffic patterns that are significantly different from the broadband traffic for mobile users, such as voice, web, video, etc. In general, traffic patterns in M2M communications will require intermittent, sometimes periodic, communication with a large number embedded devices, such that most of the time each of these embedded devices needs to operate in a ultra-low power “sleep” mode. It is our conjecture that, due to the simple modulation/coding used to send the control information in wireless cellular systems, this information can be decoded with a low power. Thus, an embedded device that is in a sleeping mode may be tuned to the secondary channel in order to receive instructions from the cellular base station about carrying out an action or sending information in the uplink. Note that with the suggested method the embedded device can only receive information in the downlink, while upon a signal received over the secondary channel it can wake up another radio interface, e.g. the usual cellular interface, and send the information. From this perspective, protocol coding offers an opportunity to introduce wake-up beacons in practically any digital communication system.

Due to their reliability and the fact that all the nodes have to decode successfully the header/control information before proceeding to decode data, the bits sent through the secondary channel can be used as supplementary error-correction bits for the original information sent in the primary system. For example, the information encoded by protocol coding may be in fact parity-check bits for the headers or the data sent in the original system.

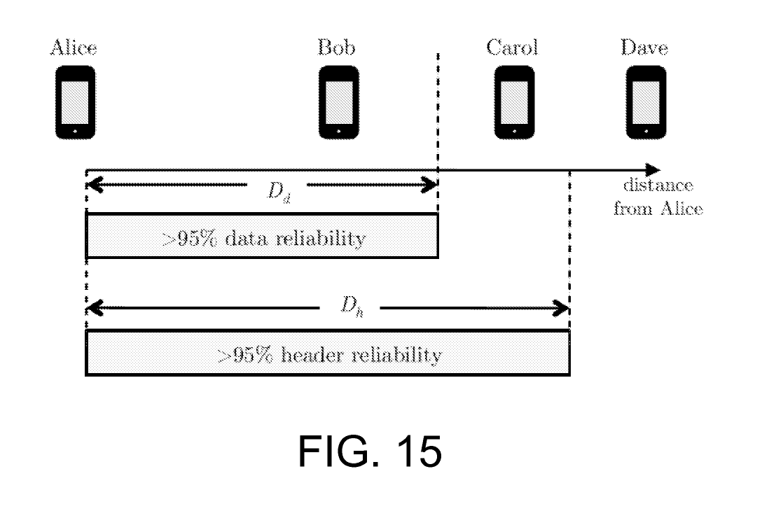

A further interesting application is range stretching for an existing communication system. Assume there is a wireless communication technology with defined RF and baseband processing and no changes in the RF/baseband are possible. Consider the communication scenario on FIG. 15, where device ‘Alice’ and device ‘Bob’ are within a rage where there is >95% data reliability, device ‘Alice’ and device ‘Carol’ are within a rage where there is >95% header reliability, device ‘Alice’ and device ‘Dave’ is at a range where data can not be transmitted reliably.

Using usual communication system, Alice can only communicate with Bob. Communication between Alice and Carol is perhaps possible, but there may be long runs of incorrect packets which may stall the protocol (such as the maximal number of retransmissions in WLAN). However, by using protocol coding over the packet headers, Alice may still be able to deliver a low, but stable, bit rate to Carol. In these scenarios protocol coding provides a graceful degradation towards “micro-bits per second”, i.e. a small number of bits may be delivered at a large distance. As mentioned above, even if the distance is such that the header detection contains errors with high probability, protocol coding may be implemented by using binary symbols −0 for absence of a packet and 1 for presence of a packet. In short, using protocol coding, transfer of bits can be achieved at larger distances without changes in the physical layers.

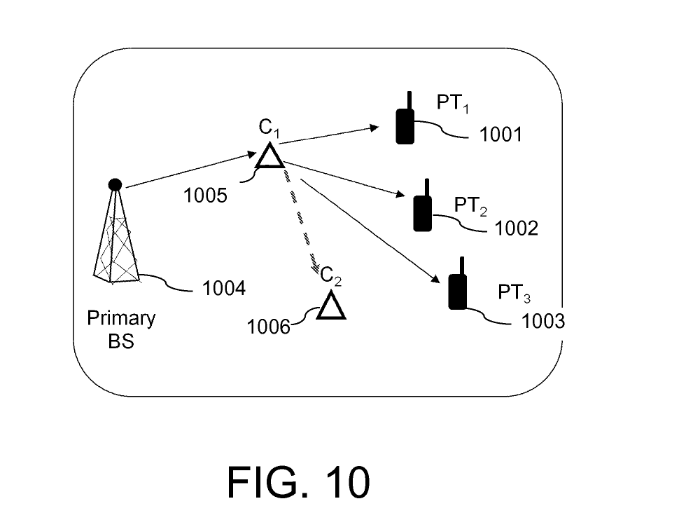

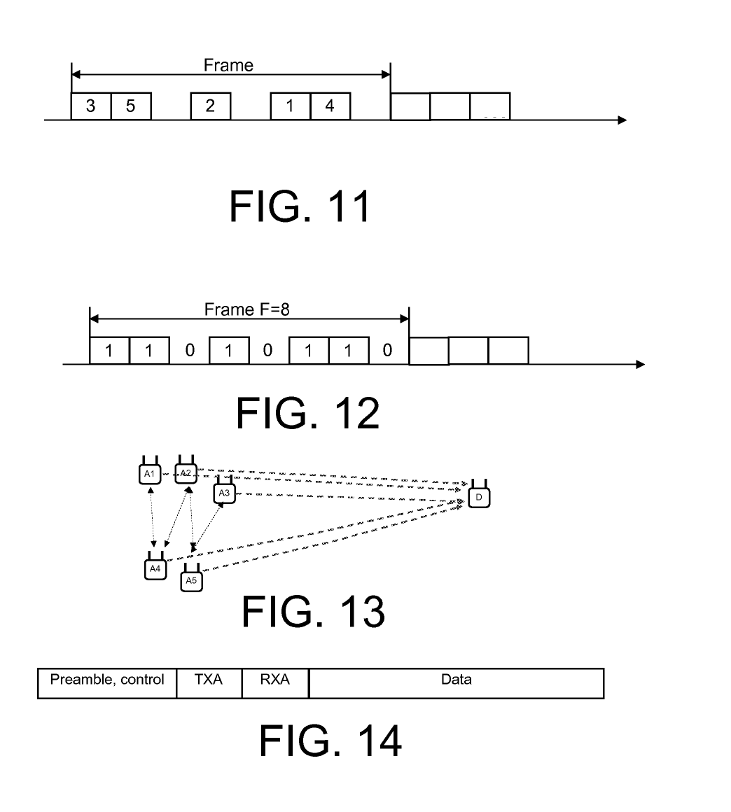

In the above part of the description it is stated that the packets or channel may be permuted based on a certain identifier contained in the header. However, there are cases in which the method of communication with packet reordering can be carried out even if the packets are not numbered or the header cannot be detected. Take for example the system on FIG. 11, where the packets are sent in frames of length F=8. In the example only 5 packets are sent during the frame and three packet slots are left empty. In such a case, we can assume that the empty packet is treated as a packet with identification number 0. In that sense, the permutation that is observed in the example frame is not 35214, but 35020140. Hence, if the receiver is able to read the header, and thus the sequential number of each packet, then the possible way to rearrange the packets when there are 5 numbered packets and 3 empty packets is 8!/5!=6720, and the number of bits that can be sent with such a number of possible orderings is:
log₂(6720)=12.7
   while if only the permutation of 5 elements is used, we can send
log₂(5!)=6.9

In some cases, it is not possible or desirable that the receiving device decodes the headers of the packet. In that case information can still be sent, as the presence of packet will be identified as “1” and absence of packet will be identified as “0”. In that case the device does not need to be able to decode the data contained in the packet, but only decode if there is a packet or not. The received sequence by this device will be interpreted as illustrated in FIG. 11.

Clearly, this device will be able to receive less data compared to the device that is able to detect also the packet headers and the sequence number. For example, if the frame has size 8 and there are only 5 packets present then the amount of bits that can be sent by picking different slots in which these packets are scheduled is

$${log}_{2} ( \begin{matrix}8 \\ 5\end{matrix} ) = 5.9$$

Nevertheless, it is important to notice that, in order to decode this information, the device does not need to employ a decoder which understands the contents of the packet. Instead, it can only use a simple energy detector to decide if a packet has been sent in a given slot. Such a detector can usually be made with low complexity and it may operate with very low power consumption.

So far we have considered cases in which a single device has data to send to one or multiple users/recipients and this device permutes the user resources in order to send additional information through protocol coding. However, similar ideas can be used to send data by using multiple devices, as the following examples are showing. In cooperative transmission multiple devices are using their transmission power to help each other in communication or to send a common message to a certain destination.

Assume that there are five devices A1, A2, A3, A4, A5, shown on FIG. 13, that are interconnected by using some short-range wireless technology, such as Bluetooth, Zigbee, WiFi, etc. Assume that device A1 needs to send a message to a faraway destination, denoted on FIG. 13 by D. The device D is also capable to receive the packets that are sent by using the short range radio technology that is used to interconnect the devices A1, A2, A3, A4, A5; however, here the term “faraway” means that the distance between D and any of the devices A1, A2, A3, A4, A5 is so large that no reliable communication is possible between D and any of the devices. Furthermore, we assume that a packet used in the applied short-range technology has the format as described on FIG. 14, such that the packet has a part of the packet header that contains the address of the sender and the address of the receiver. Such is, for example, the packet used for “Request to Send” in the IEEE 802.11 standard (Wi-Fi).

The data that A1 needs to send to D is first distributed from A1 to the other four devices by using the short range technology. To do that, A1 does not need to have a reliable direct connection to all of them. For example, A1 might be connected only to A4 (as shown on FIG. 3), A4 can send the data to A2, then A2 to A5, and finally A5 to A3. The important point is that all of the five nodes can have the data that A1 needs to send to D. For example, let the data that needs to be sent from A1 consist of 9 bits. This means that there are 2̂9=512 possible messages. Based on the actual message, the nodes A1-A5 decide how to schedule their transmissions to D. Each packet sent from node Ai (i=1 . . . 5) to D has TXA=Ai, RXA=D, but no data part. Hence, each packet is very short and contains only the part preamble, control, TXA and RXA, as depicted on FIG. 4. It is assumed that D can receive this short packet more reliably—because it is short AND because header part is usually encoded with a stronger error correcting code. Since each packet can have 5 different values for RXA, with four such packets we can represent

5̂4=625>512

such that each of the possible messages sent by A1 can be represented by a sequence of four transmissions. One possible way to do it would be the following:
Convert the 9-bit binary message into a decimal number between 0 and 511
Find the representation of this number in a numbering system with radix 5 using 4 positions. As examples of 5-ary representations: the representation of 1 is 0001, representation of 37 is 0122, representation of 100 is 0400, etc.
If the message that needs to be sent is represented in 5-ary presentation by the quadruplet X₁X₂X₃X₄, then the first transmission is done by the node Ai where i=X₁+1, the second transmission by the node the node Aj where j=X₂+1, etc. For example, if the message is represented by 2401, then first A3 sends short packet to D, then A5, then A1, and finally A2.

Based on the order in which D observes the messages addressed to it, D has an opportunity to reliably decode the original message of A1. Clearly, this happens when there is certain reliability in the reception of the short packets at D. It should be noted that the original data sent by A1 can employ error correcting code, such that D can decode the message even if some of the short packets from the nodes A1-A5 have not been received correctly. For examples on the methods for encoding/decoding with error protection, refer to the section “Encoding/Decoding” below.

The main value of the presented method is that it allows A to extend the range without changing the radio interface, but only the scheduling of the packets at the higher layers.

Another example where this kind of communication can be useful is information about a sensory event. If A1-A5 are nodes with sensing capabilities, they might observe some phenomenon, exchange information relating to the sensor, e.g. if there is an alarm, to assess the reliability of this alarm, and then use the presented method and/or system to broadcast the information about this alarm as far as possible (i.e. not to a particular destination D).

1. A method for communicating an intended information between a sender and a receiver in a communication system, the method comprising:
a) providing a plurality of elements to be sent from the sender to the receiver, the plurality of elements being in a first order;
b) sending to the receiver the elements in a second order, the second order representing the intended information;
c) receiving the plurality of elements;
d) determining whether an order in which the elements have been received is different from the first order;
e) if the order in which the elements have been received is different from the first order, determining information based on the order in which the elements have been received;
f) if the order in which the elements have been received is the second order, the information determined is the intended information.

2-35. (canceled)

36. The method according to claim 1, wherein the plurality of elements is selected from the group consisting of a plurality of data blocks, a plurality of data packets, a plurality of codes, a plurality of channelization codes, a plurality of resources, a plurality of channels, a plurality of addresses, and a plurality of terminals or any combination thereof.

37. The method according to claim 1, said method further comprising the step of providing a sequence being an ordered arrangement of a plurality of elements in a set and representing the intended information to be communicated from the sender to the receiver.

38. The method according to claim 1, wherein the second order results from arranging the plurality of elements according to a sequence, the sequence being an ordered arrangement of a plurality of elements in a set and representing the intended information to be communicated from the sender to the receiver.

39. The method according to claim 37, wherein the sequence is a permutation of the plurality of elements, or a combination of the plurality of elements.

40. The method according to claim 1, wherein the first order represents intended information to be communicated from the sender to the receiver.

41. The method according to claim 1, said method further comprising the step of arranging the plurality of elements into a second order before sending the plurality of elements to the at least one receiver.

42. The method according to claim 41, said method further comprising arranging a plurality of resources allocated to a plurality of terminals in a second order representing the information.

43. The method according to claim 42, wherein a resource is a channel, a code, a frequency, or a time interval or any combination thereof.

44. The method according to claim 1, said method further comprising arranging a plurality of channel codes assigned to a plurality of terminals in a second order representing the information to be communicated to the receiver.

45. The method according to claim 44, wherein the plurality of channel codes assigned to a plurality of terminals is a plurality of channel codes for cellular systems.

46. The method according to claim 41, wherein the arrangement of the plurality of elements into the second order is an encoding technique.

47. The method according to claim 1, wherein the first order is present in a first system and, wherein the second order is implemented by the first system and the first and second order are used by a second system.

48. The method according to claim 1, wherein an arrangement of the plurality of elements sent to a receiver is a code for correcting an error present in the plurality of elements received.

49. The method according to claim 1, wherein the communicating is performed by a communication system selected from the group consisting of a Wireless local area network, a wireless metropolitan network, a cellular system, a digital television system, a cognitive radio system, a satellite communication system, and a short-range communication system or any combination thereof.

50. The method according to claim 1, wherein the plurality of terminals is selected from the group consisting of a plurality of receivers, a plurality of senders, and a plurality of transceivers, or any combination thereof.

51. The method according to claim 1, wherein sending in a communication system the plurality of elements into a second order representing the information provides to the communication system an additional in-band capacity.

52. The method according to claim 1, wherein the method regulates and allows a transmission through a cognitive radio.

53. The method according to claim 1, wherein sending the plurality of elements of a first system into the second order representing the information provides to a second system an additional in-band capacity.

54. The method according to claim 53, wherein sending the plurality of elements of a first system into the second order to communicate the information provides to a second system an additional in-band signaling capacity, the first system being a Digital Television system and the second system being a non-Digital Television system.

55. The method according to claim 53 wherein:
a) In a first system, a relaying system forwards the plurality of elements in the second order representing the information, the plurality of elements being sent to a receiver of the first system;
b) and, in a second system, the information is determined based on the second order in which the elements are received at the receiver of the second system, the information being intended to the receiver of the second system.

56. The method according to claim 1, wherein the at least one receiver is located at an edge of a cell of the communication system.

57. The method according to claim 1, wherein the at least one receiver is located in a wireless communication system, said at least one receiver receiving a wireless signal being weaker than at other positions of the wireless communication system.

58. The method according to claim 1, wherein a second order representing the intended information communicated from the sender to the at least one receiver is in a header of an element sent over a channel announcing an allocation of a plurality of channels to a plurality of terminals.

59. The method according to claim 1, wherein a second order representing the intended information communicated from the sender to the at least one receiver supports a handover of the at least one receiver in a communication system.

60. The method according to claim 1, wherein a second order representing the intended information communicated from the sender to the at least one receiver coordinates a usage of a spectrum among a plurality of terminals.

61. The method according to claim 58, wherein the communication is performed by a communication system selected from the group consisting of a wireless LAN, a short range communication system, a cellular system, and a satellite communication system or any combination thereof.

62. The method according to claim 1, wherein the information communicated from the sender to the at least one receiver is secret.

63. A receiver apparatus comprising at least one of the following:
a) a receiving device receiving a plurality of elements from a sender;
b) a device for determining whether an order in which the elements have been received is different from the first order;
c) if the order in which the elements have been received is different from the first order, a device for determining information based on an order in which the plurality of elements are received;
d) a device for determining information based on a header of an element received on a channel in a communication system.

64. The receiver apparatus according to claim 63, further comprising a device for receiving from a sender a plurality of elements that is not destined to the receiver.

65. A sender apparatus comprising:
a) a means for providing a plurality of elements to be sent to the at least one receiver, the plurality of elements being arranged in a first order; and
b) a means for sending to the at least one receiver the plurality of elements in a second order, the second order representing an information to be communicated to the receiver.

66. The sender apparatus according to claim 65, further comprising a means for generating a combinatorial sequence to arrange the second order so as to represent the information to be communicated to the receiver.

67. The sender apparatus according to claim 65, further comprising a means for arranging the plurality of elements into a second order according to a combinatorial sequence representing information to be communicated to the receiver before sending the plurality of elements to the at least one receiver.

68. A system for communicating intended information from a sender to a receiver comprising:
a) a sender apparatus adapted to:
i. provide a plurality of elements to be sent from the sender to the at least one receiver, the plurality of elements being arranged in a first order;
ii. send to the at least one receiver the plurality of elements in a second order, the second order representing the intended information;
b) a receiver apparatus adapted to:
i. receive a plurality of elements;
ii. determine whether an order in which the elements have been received is different from the first order;
iii. If the order in which the elements have been received is different from the first order, determining an information based on the order in which the elements have been received;
iv. If the order in which the elements have been received is the second order, the information determined is the intended information.

69. A computer-readable medium comprising a computer program for an apparatus for performing the method according to claim 1.
